(19) United States
(12) Patent Application Publication
(10) Pub. No.: US 2024/0264455 A1
(43) Pub. Date: Aug. 8, 2024

(54) OPTICAL WAVEGUIDE PLATE, OPTICAL SYSTEM, COMPOSITE OPTICAL SYSTEM AND NEAR-EYE DISPLAY APPARATUS

(71) Applicant: LARGAN PRECISION CO., LTD., Taichung City (TW)

(72) Inventors: Chun-Che HSUEH, Taichung City (TW); Yu Jie HONG, Taichung City (TW); Chun-Hung TENG, Taichung City (TW)

(21) Appl. No.: 18/428,201

(22) Filed: Jan. 31, 2024

(30) Foreign Application Priority Data
Feb. 3, 2023 (TW) 112103765

(51) Int. Cl. G02B 27/12; G02B 6/43; G02B 27/01

(52) U.S. Cl. CPC G02B 27/123; G02B 6/43; G02B 27/0172

(57) ABSTRACT

An optical waveguide plate has a front surface and a back surface, and includes an in-coupling element and an out-coupling element. The in-coupling element and the out-coupling element are disposed on at least one of the front surface and the back surface. An in-coupling area is an area of the at least one of the front surface and the back surface on which the in-coupling element is disposed, and an out-coupling area is an area of the at least one of the front surface and the back surface on which the out-coupling element is disposed. A thickness of the optical waveguide plate is gradually increased from the in-coupling area towards the out-coupling area.

### RELATED APPLICATIONS

This application claims priority to Taiwan Application Serial Number 112103765, filed Feb. 3, 2023, which is herein incorporated by reference.

### BACKGROUND

### Technical Field

The present disclosure relates to an optical waveguide plate, an optical system and a composite optical system. More particularly, the present disclosure relates to an optical waveguide plate, an optical system and a composite optical system applicable to a near-eye display apparatus.

### DESCRIPTION OF RELATED ART

Based on the advancement of the technology, the variety of elements are becoming compact size so as to gradually achieve the devices which only appeared in the science fiction, wherein a near-eye display apparatus is one of the most popular developing product. In recent years, the near-eye display apparatus has multiple kinds of the disposition, such as a pancake structure which is commonly used in a virtual reality (VR), a birdbath structure which is commonly used in an augmented reality (AR) and a waveguide structure. In contrast to the near-eye display apparatus which is configured to directly project on the retina, all of the pancake structure, the birdbath structure and the waveguide structure have the characteristic of small volume, wherein each of the pancake structure and the birdbath structure includes a polarizing element and a portion of a reflecting element, so that the use efficiency of the light is low (that is, the light efficiency is low). Further, the polarizing element and the portion of the reflecting element occupy the volume of the pancake structure and the volume of the birdbath structure, so that the volume of the pancake structure and the volume of the birdbath structure are larger than the volume of the waveguide structure, and the waveguide structure only requires an optical waveguide plate to form the total internal reflection of the light, so that the waveguide structure has the smaller volume and higher light efficiency than the pancake structure and the birdbath structure do.

The waveguide structure is favorable for carrying so as to become the recently popular optical structure. However, the waveguide structure has some defects which cannot be conquered, wherein the narrow viewing angle and the rainbow effect formed via the chromatic aberration are the obvious defects of the waveguide structure, and hence the aforementioned defects should be positively conquered. Therefore, an optical waveguide plate, which can expand the viewing angle and enhance the imaging quality, needs to be developed.

### SUMMARY

According to one aspect of the present disclosure, an optical waveguide plate has a front surface and a back surface, and includes an in-coupling element and an out-coupling element. The in-coupling element and the out-coupling element are disposed on at least one of the front surface and the back surface. An in-coupling area is an area of the at least one of the front surface and the back surface on which the in-coupling element is disposed, and an out-coupling area is an area of the at least one of the front surface and the back surface on which the out-coupling element is disposed. A thickness of the optical waveguide plate is gradually increased from the in-coupling area towards the out-coupling area.

According to one aspect of the present disclosure, an optical system includes the optical waveguide plate of the aforementioned aspect and an image providing device, wherein the image providing device is disposed on a front side or a back side of the optical waveguide plate.

According to one aspect of the present disclosure, a composite optical system includes at least two of the optical systems of the aforementioned aspect.

According to one aspect of the present disclosure, a near-eye display apparatus includes the optical system of the aforementioned aspect and an outer cover carrier, wherein the optical system is disposed in the outer cover carrier.

According to one aspect of the present disclosure, an optical waveguide plate has a front surface and a back surface, and includes an in-coupling element and an out-coupling element. The in-coupling element and the out-coupling element are disposed on at least one of the front surface and the back surface. An in-coupling area is an area of the at least one of the front surface and the back surface on which the in-coupling element is disposed, and an out-coupling area is an area of the at least one of the front surface and the back surface on which the out-coupling element is disposed. At least one of the front surface and the back surface of the optical waveguide plate is a curved surface, and the curved surface is an aspheric surface. The in-coupling area has an in-coupling area standard point, and the out-coupling area has an out-coupling area standard point. An in-coupling area corresponding point is an intersection of the in-coupling area standard point from the at least one of the front surface and the back surface on which the in-coupling element is disposed extending towards the other one of the front surface and the back surface on which the in-coupling element is disposed along a normal line. An out-coupling area corresponding point is an intersection of the out-coupling area standard point from the at least one of the front surface and the back surface on which the out-coupling element is disposed extending towards the other one of the front surface and the back surface on which the out-coupling element is disposed along the normal line.

According to one aspect of the present disclosure, an optical system includes the optical waveguide plate of the aforementioned aspect and an image providing device, wherein the image providing device is disposed on a front side or a back side of the optical waveguide plate.

According to one aspect of the present disclosure, a near-eye display apparatus includes the optical system of the aforementioned aspect and an outer cover carrier, wherein the optical system is disposed in the outer cover carrier.

### BRIEF DESCRIPTION OF THE DRAWINGS

FIG. 1 is a schematic view of an optical system according to an embodiment of the present disclosure.

FIG. 2 is a partial schematic view of an optical waveguide plate according to the 1 st example of the present disclosure.

FIG. 3 is a partial cross-section view of an optical waveguide plate according to the 2nd example of the present disclosure.

FIG. 4 is a partial cross-section view of an optical waveguide plate according to the 3rd example of the present disclosure.

FIG. 5 is a schematic view of a composite optical system according to the 6th example of the present disclosure.

FIG. 6 is a schematic view of a near-eye display apparatus according to the 7th example of the present disclosure.

### DETAILED DESCRIPTION

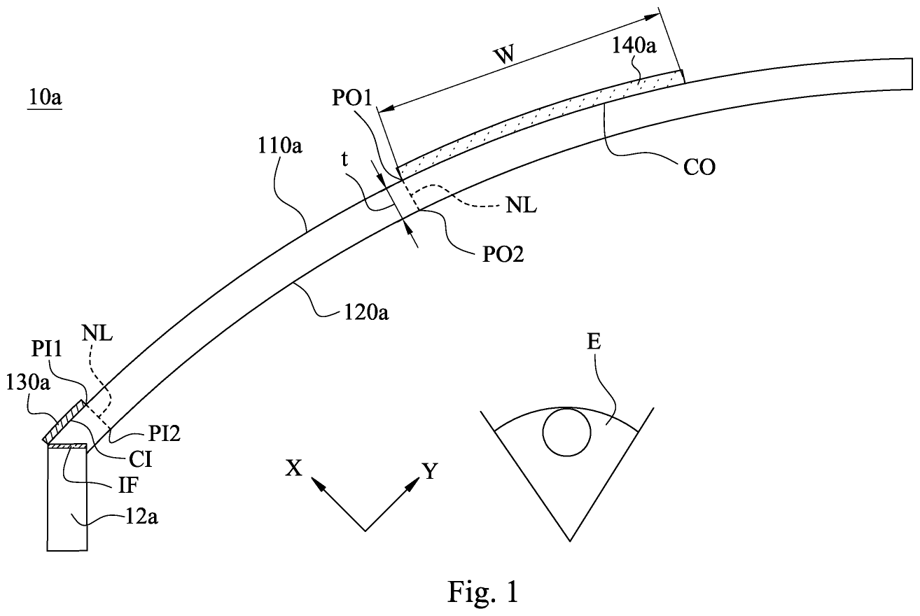

FIG. 1 is a schematic view of an optical system 10a according to an embodiment of the present disclosure. It should be mentioned that the optical system of the present disclosure is not limited to the optical system 10a of FIG. 1. In FIG. 1, the present disclosure provides the optical system 10a, which includes an optical waveguide plate (its reference numeral is omitted) and an image providing device 12a, wherein the image providing device 12a is disposed on a front side or a back side of the optical waveguide plate, the optical waveguide plate has a front surface 110a and a back surface 120a, and the optical waveguide plate includes a coupling element (its reference numeral is omitted). In particular, the coupling element includes an in-coupling element 130a and an out-coupling element 140a, and the in-coupling element 130a and the out-coupling element 140a are disposed on at least one of the front surface 110a and the back surface 120a, wherein an in-coupling area CI is an area of the at least one of the front surface 110a and the back surface 120a on which the in-coupling element 130a is disposed, and an out-coupling area CO is an area of the at least one of the front surface 110a and the back surface 120a on which the out-coupling element 140a is disposed. Therefore, the volume of the optical element can be reduced via the optical waveguide plate, and the leakage of the imaging light can be reduced by the total internal reflection of the optical waveguide plate so as to enhance the luminous effect.

In detail, the optical waveguide plate can be made of a glass, a semiconductor, a plastic or a composite material, the image providing way of the image providing device 12a can be a laser, a digital light processing (DLP), a liquid crystal display (LCD) or a liquid crystal on silicon (LCoS), the type of the light source or the display panel of the image providing device 12a can be a light emitting diode (LED), a quantum dot light emitting diode (QLED), an organic light emitting diode (OLED), a mini light emitting diode (Mini LED), a micro light emitting diode (Micro LED) or a micro organic light emitting diode (Micro OLED), but the present disclosure is not limited thereto.

In particular, the front surface 110a and the back surface 120a of the optical waveguide plate can be defined as two sides of the optical waveguide plate away from and close to a user's eye E, respectively. Or, the back surface 120a of the optical waveguide plate can be defined as a side of an image surface emitting light of the optical system 10a to leave the optical waveguide plate, and the front surface 110a of the optical waveguide plate is an opposite side of the back surface 120a, wherein an image surface IF is located on the image providing device 12a, and the image surface emitting light is provided via the image surface IF.

A thickness of the optical waveguide plate can be gradually increased from the in-coupling area CI towards the out-coupling area CO. Therefore, via the optical waveguide plate with gradually increasing thickness, the total internal reflection angle can be enlarged and an area of the out-coupling area CO can be increased, so that a viewing angle of the optical waveguide plate can be enlarged.

At least one of the front surface 110a and the back surface 120a of the optical waveguide plate can be a curved surface, and the curved surface can be an aspheric surface. Therefore, the imaging quality can be enhanced via the optical waveguide plate with the curved surface. Moreover, the imaging quality can be further enhanced by disposing the curved surface as the aspheric surface.

In detail, the in-coupling element 130a can be disposed on the front surface 110a or the back surface 120a of the optical waveguide plate, and the image surface emitting light provided via the image surface IF can be guided in the optical waveguide plate or the image surface emitting light can be transformed into the total internal reflecting light via the in-coupling element 130a. The out-coupling element 140a can be disposed on the front surface 110a or the back surface 120a of the optical waveguide plate, and the image surface emitting light provided via the image surface IF can be guided out the optical waveguide plate or the image surface emitting light can be transformed into the non-total internal reflecting light via the out-coupling element 140a. The action principle of the coupling element can be reflection, refraction or diffraction, the coupling element can be a prism, a microprism array, an embedded reflecting mirror array, a diffractive element, a diffractive grating, a surface relief grating, a holographic grating, a simulated holographic grating with thinner or thicker thickness, a metasurface, a resonant waveguide grating, a beam splitter, a curved synthesizer or an optical element with freeform. At least one of the in-coupling element and the out-coupling element can be the holographic grating. Therefore, the angle of the image emitting light exiting the optical waveguide plate can be expanded. In particular, the in-coupling element 130a and the out-coupling element 140a have different special effects because of the different types, such as expanding the viewing angle, reducing the volume and the easy disposition, but the present disclosure is not limited thereto.

In particular, an in-coupling area CI is an area of the at least one of the front surface 110a and the back surface 120a on which the in-coupling element 130a is disposed, and an out-coupling area CO is an area of the at least one of the front surface 110a and the back surface 120a on which the out-coupling element 140a is disposed. Further, each of the in-coupling area CI and the out-coupling area CO can be a plane or a curved surface, and one of the front surface 110a and the back surface 120a of the optical waveguide plate can simultaneously have the in-coupling area CI and the out-coupling area CO.

Moreover, when the optical system has at least two out-coupling elements 140a, at least two image emitting lights can be combined to form the image with larger viewing angle, and the combination of the image emitting lights is mainly formed by the combination of at least two out-coupling areas CO, wherein at least two out-coupling areas CO can be adjacent to each other so as to form the larger viewing angle. Or, at least two out-coupling areas CO can be non-adjacent to each other, and the image combination of the image emitting light on the retina can be simulated via the software to form the larger viewing angle. When the optical waveguide plate has at least two out-coupling areas CO, the in-coupling area CI and the out-coupling area CO on the same group of the image emitting light path are only calculated.

The in-coupling area CI has an in-coupling area standard point PI1, and the out-coupling area CO has an out-coupling area standard point PO1. Further, an in-coupling area corresponding point PI2 is an intersection of the in-coupling area standard point PI1 from the at least one of the front surface 110a and the back surface 120a on which the in-coupling element 130a is disposed extending towards the other one of the front surface 110a and the back surface 120a on which the in-coupling element 130a is disposed along a normal line NL. In FIG. 1, the in-coupling area standard point PI1 is disposed on the front surface 110a, and the in-coupling area corresponding point PI2 is the intersection of the in-coupling area standard point PI1 from the front surface 110a extending towards the back surface 120a along the normal line NL. Further, an out-coupling area corresponding point PO2 is an intersection of the out-coupling area standard point PO1 from the at least one of the front surface 110a and the back surface 120a on which the out-coupling element 140a is disposed extending towards the other one of the front surface 110a and the back surface 120a on which the out-coupling element 140a is disposed along the normal line NL. In FIG. 1, the out-coupling area standard point PO1 is disposed on the front surface 110a, and the out-coupling area corresponding point PO2 is the intersection of the out-coupling area standard point PO1 from the front surface 110a extending towards the back surface 120a along the normal line NL. In particular, the front surface 110a of the optical waveguide plate has the in-coupling area standard point PI1 or the in-coupling area corresponding point PI2, and a curvature of the in-coupling area standard point PI1 or a curvature of the in-coupling area corresponding point PI2 of the front surface 110a of the optical waveguide plate is a negative value. Therefore, the reflecting angle reflected via the front surface 110a of the optical waveguide plate can be enhanced by the front surface 110a of the optical waveguide plate with the negative curvature value. Or, the back surface 120a of the optical waveguide plate has the in-coupling area standard point PI1 or the in-coupling area corresponding point PI2, and the curvature of the in-coupling area standard point PI1 or the curvature of the in-coupling area corresponding point PI2 of the back surface 120a of the optical waveguide plate is a positive value. Therefore, the reflecting angle reflected via the back surface 120a of the optical waveguide plate can be enhanced by the back surface 120a of the optical waveguide plate with the positive curvature value.

Furthermore, the in-coupling area standard point PI1 and the out-coupling area standard point PO1 are two points which are the closest to each other on the linear distance between the in-coupling area CI and the out-coupling area CO, respectively. When the in-coupling area CI and the out-coupling area CO have parallel sides to each other, at least two kinds of the combination of the in-coupling area standard point PI1 and the out-coupling area standard point PO1 are formed, wherein the in-coupling area standard point PI1 and the out-coupling area standard point PO1 can be located on the same side surface or the different side surfaces of the optical waveguide plate.

There are multiple variations of the location of the in-coupling element 130a and the location of the out-coupling element 140a, and there are multiple combinations of the location of the in-coupling area standard point PI1 and the location of the out-coupling area standard point PO1. In particular, when the in-coupling area CI is located on the front surface 110a and the out-coupling area CO is located on the back surface 120a, the in-coupling area standard point PI1 and the out-coupling area corresponding point PO2 are located on the front surface 110a, and the in-coupling area corresponding point PI2 and the out-coupling area standard point PO1 are located on the back surface 120a. When the in-coupling area CI is located on the back surface 120a and the out-coupling area CO is located on the front surface 110a, the in-coupling area corresponding point PI2 and the out-coupling area standard point PO1 are located on the front surface 110a, and the in-coupling area standard point PI1 and the out-coupling area corresponding point PO2 are located on the back surface 120a.

The axial direction of the optical waveguide plate can be separated from an axis X and an axis Y, wherein the in-coupling area standard point PI1 is set as the beginning, the axis X is the normal line NL of the in-coupling area standard point PI1 on the front surface 110a or the back surface 120a of the optical waveguide plate extends, the moving direction from the front surface 110a of the optical waveguide plate towards the back surface 120a of the optical waveguide plate along the axis X is the positive direction. The in-coupling area standard point PI1 has a tangent line on the front surface 110a or the back surface 120a of the optical waveguide plate, the axis Y is the extension of the tangent line, and the moving direction of the axis Y from the in-coupling area CI towards the out-coupling area CO is the positive direction.

Moreover, the connection on the same side surface of the optical waveguide plate between the out-coupling area standard point PO1 or the out-coupling area corresponding point PO2 and the in-coupling area standard point PI1 is a standard connecting line, wherein the out-coupling area standard point PO1 or the out-coupling area corresponding point PO2 is located on the same side surface (that is, the front surface 110a or the back surface 120a) of the in-coupling area standard point PI1. The connection on the same side surface of the optical waveguide plate between the out-coupling area standard point PO1 or the out-coupling area corresponding point PO2 and the in-coupling area corresponding point PI2 is a corresponding connecting line, wherein the out-coupling area standard point PO1 or the out-coupling area corresponding point PO2 is located on the same side surface of the in-coupling area corresponding point PI2.

A curvature absolute value of the front surface 110a of the optical waveguide plate from the in-coupling area CI towards the out-coupling area CO can be gradually decreased. Therefore, the surface shape of the optical waveguide plate from the in-coupling area CI towards the out-coupling area CO is gradually even so as to avoid shrinking the angle of the reflecting light.

A curvature absolute value of the back surface 120a of the optical waveguide plate from the in-coupling area CI towards the out-coupling area CO can be gradually decreased. Therefore, the surface shape of the optical waveguide plate from the in-coupling area CI towards the out-coupling area CO is gradually even so as to avoid shrinking the angle of the reflecting light.

It should be mentioned that the measuring method of the curvature of the surface of the optical waveguide plate is to take a measurement point on the standard connecting line or the corresponding connecting line, each point is obtained by the measurement point on a direction of the axis Y at a height of plus or minus 1×10⁻¹⁰ mm and on the standard connecting line or the corresponding connecting line, an arc is formed via the aforementioned two points and the measurement point, and a curvature of the arc is regarded as a curvature of a measuring point. If the point is the in-coupling area standard point PI1, the in-coupling area corresponding point PI2, the out-coupling area standard point PO1 or the out-coupling area corresponding point PO2, the point is obtained by extending the standard connecting line or the corresponding connecting line towards the in-coupling area CI or the out-coupling area CO on a direction of the axis Y at the height of 1×10⁻¹⁰ mm, and the curvature is distinguished whether positive or negative via the direction of the axis X. Further, the curvature of the in-coupling area standard point PI1, the curvature of the in-coupling area corresponding point PI2, the curvature of the out-coupling area standard point PO1 and the curvature of the out-coupling area corresponding point PO2 of the optical waveguide plate can be the positive value or the negative value.

Moreover, the curvature can be configured to judge the surface shape of the optical waveguide plate, and the surface shape of the optical waveguide plate is the surface shape of the standard connecting line and the surface shape of the corresponding connecting line, wherein the surface shape of the optical waveguide plate can be a plane or a curved surface, and the curved surface can be a spherical surface or an aspheric surface. The curvature trend of the front surface 110a or the back surface 120a of the optical waveguide plate from the in-coupling area CI towards the out-coupling area CO is the comparison of any two points on the standard connecting line or the comparison of any two points on the corresponding connecting line. For example, when the in-coupling area standard point PI1 and the out-coupling area standard point PO1 are located on the same side surface, any two points on the standard connecting line can be the in-coupling area standard point PI1 and the out-coupling area standard point PO1. Or, one of any two points on the standard connecting line can be the in-coupling area standard point PI1, and the other one of any two points can be the location point on a direction from the in-coupling area standard point PI1 towards the out-coupling area standard point PO1 at a height of the axis Y of 0.1 mm, 0.2 mm, 0.3 mm, 0.4 mm, 0.5 mm, 1 mm, 2 mm, 3 mm, 4 mm or 5 mm. Or, one of any two points on the standard connecting line can be the out-coupling area standard point PO1, and the other one of any two points can be the location point on a direction from the in-coupling area standard point PI1 towards the out-coupling area standard point PO1 at the height of the axis Y of 0.1 mm, 0.2 mm, 0.3 mm, 0.4 mm, 0.5 mm, 1 mm, 2 mm, 3 mm, 4 mm or 5 mm, but the present disclosure is not limited thereto.

When a refractive index of the optical waveguide plate is N, the following condition can be satisfied: 1.8≤N. Hence, the critical angle of the total internal reflection can be lowered via the optical waveguide plate with high refractive index, the total amount of the light of the total internal reflection can be increased, and the imaging quality can be enhanced. Further, the following condition can be satisfied: 1.9≤N. Further, the following condition can be satisfied: 2.0≤N.

When a length of the out-coupling area CO is W, and a thickness of the optical waveguide plate at the out-coupling area standard point PO1 is t, the following condition can be satisfied: 0.57≤W/2 t≤1.00×10¹⁸. Therefore, the total internal reflection angle can be enhanced, and the viewing angle of the optical waveguide plate can be expanded. Further, the following condition can be satisfied: 0.83≤W/2 t≤1.00×10¹⁵. Further, the following condition can be satisfied: 1.19≤W/2 t≤1.00×10¹². Further, the following condition can be satisfied: 1.73≤W/2 t≤1.00×10¹⁰. Further, the following condition can be satisfied: 2.74≤W/2 t≤1.00×10⁵.

When the length of the out-coupling area CO is W, the following condition can be satisfied: 1.00 mm≤W. Further, the following condition can be satisfied: 1.50 mm≤W. Further, the following condition can be satisfied: 2.00 mm≤W. Further, the following condition can be satisfied: 2.50 mm≤W≤50.00 mm. Further, the following condition can be satisfied: 3.00 mm≤W≤25.00 mm.

When the thickness of the optical waveguide plate at the out-coupling area standard point PO1 is t, the following condition can be satisfied: t≤3.00 mm. Further, the following condition can be satisfied: t≤2.50 mm. Further, the following condition can be satisfied: 0 mm<t≤2.00 mm. Further, the following condition can be satisfied: 0.25 mm≤t≤1.75 mm. Further, the following condition can be satisfied: 0.5 mm≤t≤1.50 mm.

In FIG. 1, the aforementioned length of the out-coupling area CO is the linear distance between two sides of the out-coupling area CO, and one of two sides of the aforementioned out-coupling area CO includes the out-coupling area standard point PO1. Further, the aforementioned thickness of the optical waveguide plate on the out-coupling area standard point PO1 is the length between the intersection from the measuring point on the front surface 110a along the normal line NL and the intersection from the measuring point on the back surface 120a of the optical waveguide plate by taking the measuring point on the standard connecting line. For example, the thickness of the optical waveguide plate on the in-coupling area standard point PI1 is the length of the optical waveguide plate of the connection between the in-coupling area standard point PI1 and the in-coupling area corresponding point PI2. The thickness trend of the optical waveguide plate from the in-coupling area CI towards the out-coupling area CO is the comparison of any two points on the standard connecting line. When the in-coupling area standard point PI1 and the out-coupling area standard point PO1 are located on the same side surface, any two points on the standard connecting line can be the in-coupling area standard point PI1 and the out-coupling area standard point PO1. Or, one of any two points on the standard connecting line can be the in-coupling area standard point PI1, and the other one of any two points on the standard connecting line can be the location point on the direction from the in-coupling area standard point PI1 towards the out-coupling area standard point PO1 at the height of the axis Y of 0.1 mm, 0.2 mm, 0.3 mm, 0.4 mm, 0.5 mm, 1 mm, 2 mm, 3 mm, 4 mm or 5 mm. Or, one of any two points on the standard connecting line can be the out-coupling area standard point PO1, and the other one of any two points on the standard connecting line can be the location point on the direction from the in-coupling area standard point PI1 towards the out-coupling area standard point PO1 at the height of the axis Y of 0.1 mm, 0.2 mm, 0.3 mm, 0.4 mm, 0.5 mm, 1 mm, 2 mm, 3 mm, 4 mm or 5 mm, but the present disclosure is not limited thereto.

When the curvature of the in-coupling area standard point PI1 is Cis, and the curvature of the in-coupling area corresponding point PI2 is Cic, the following condition can be satisfied: Cis≤Cic. Therefore, the reflection of the imaging light on the in-coupling area CI can be stable.

When the curvature of the in-coupling area standard point PI1 is Cis, and a curvature of the out-coupling area standard point PO1 is Cos, the following condition can be satisfied: Cis≤Cos. Therefore, the internal reflecting angle of the optical waveguide plate can be expanded.

When the curvature of the in-coupling area standard point PI1 is Cis, and a curvature of the out-coupling area corresponding point PO2 is Coc, the following condition can be satisfied: Cis≤Coc. Therefore, the internal reflecting angle of the optical waveguide plate can be expanded.

When the curvature of the in-coupling area standard point PI1 is Cis, and the curvature of the in-coupling area corresponding point PI2 is Cic, the following condition can be satisfied: Cic≤Cis. Therefore, the reflecting angle of the imaging light on the in-coupling area CI can be expanded.

When the curvature of the in-coupling area corresponding point PI2 is Cic, and the curvature of the out-coupling area standard point PO1 is Cos, the following condition can be satisfied: Cic≤Cos. Therefore, the internal reflecting angle of the optical waveguide plate can be expanded.

When the curvature of the in-coupling area corresponding point PI2 is Cic, and the curvature of the out-coupling area corresponding point PO2 is Coc, the following condition can be satisfied: Cic≤Coc. Therefore, the internal reflecting angle of the optical waveguide plate can be expanded.

When the curvature of the in-coupling area standard point PI1 is Cis, and the curvature of the out-coupling area standard point PO1 is Cos, the following condition can be satisfied: |Cos|≤|Cis|. Therefore, the surface shape of the optical waveguide plate from the in-coupling area CI towards the out-coupling area CO is gradually even so as to avoid shrinking the angle of the reflecting light.

When the curvature of the in-coupling area corresponding point PI2 is Cic, and the curvature of the out-coupling area corresponding point PO2 is Coc, the following condition can be satisfied: |Coc|≤|Cic|. Therefore, the surface shape of the optical waveguide plate from the in-coupling area CI towards the out-coupling area CO is gradually even so as to avoid shrinking the angle of the reflecting light.

When a curvature radius of the in-coupling area standard point PI1 is Ris, and a curvature radius of the out-coupling area standard point PO1 is Ros, the following condition can be satisfied: |Ris|≤|Ros|. Therefore, the surface shape of the optical waveguide plate from the in-coupling area CI towards the out-coupling area CO is gradually even so as to avoid shrinking the angle of the reflecting light.

When the curvature of the in-coupling area standard point PI1 is Cis, the following condition can be satisfied: −1.00 (1/mm)≤Cis≤1.00 (1/mm). Further, the following condition can be satisfied: −0.50 (1/mm)≤Cis≤0.50 (1/mm). Further, the following condition can be satisfied: −0.25 (1/mm)≤Cis≤0.25 (1/mm). Further, the following condition can be satisfied: −0.10 (1/mm)≤Cis≤0.10 (1/mm).

When the curvature of the in-coupling area standard point PI1 is Cis, the following condition can be satisfied: 0.00 (1/mm)≤|Cis|. Further, the following condition can be satisfied: 0.05 (1/mm)≤|Cis|. Further, the following condition can be satisfied: 0.10 (1/mm)≤|Cis|. Further, the following condition can be satisfied: 0.30 (1/mm)≤|Cis|. Further, the following condition can be satisfied: 0.50 (1/mm)≤|Cis|≤1.00×10¹⁸ (1/mm).

When the curvature of the in-coupling area corresponding point PI2 is Cic, the following condition can be satisfied: −1.00 (1/mm)≤Cic≤1.00 (1/mm). Further, the following condition can be satisfied: −0.50 (1/mm)≤Cic≤0.50 (1/mm). Further, the following condition can be satisfied: −0.25 (1/mm)≤Cic≤0.25 (1/mm). Further, the following condition can be satisfied: −0.10 (1/mm)≤Cic≤0.10 (1/mm).

When the curvature of the in-coupling area corresponding point PI2 is Cic, the following condition can be satisfied: 0.00 (1/mm)≤|Cic|. Further, the following condition can be satisfied: 0.05 (1/mm)≤|Cic|. Further, the following condition can be satisfied: 0.10 (1/mm)≤|Cic|. Further, the following condition can be satisfied: 0.30 (1/mm)≤|Cic|. Further, the following condition can be satisfied: 0.50 (1/mm)≤|Cic|≤1.00×10¹⁸ (1/mm).

When the curvature of the out-coupling area standard point PO1 is Cos, the following condition can be satisfied: −1.00 (1/mm)≤Cos≤1.00 (1/mm). Further, the following condition can be satisfied: −0.50 (1/mm)≤Cos≤0.50 (1/mm). Further, the following condition can be satisfied: −0.25 (1/mm)≤Cos≤0.25 (1/mm). Further, the following condition can be satisfied: −0.10 (1/mm)≤Cos≤0.10 (1/mm). Further, the following condition can be satisfied: −0.05 (1/mm)≤Cos≤0.05 (1/mm).

When the curvature of the out-coupling area standard point PO1 is Cos, the following condition can be satisfied: 0.00 (1/mm)≤|Cos|. Further, the following condition can be satisfied: 0.05 (1/mm)≤|Cos|. Further, the following condition can be satisfied: 0.10 (1/mm)≤|Cos|. Further, the following condition can be satisfied: 0.30 (1/mm)≤|Cos|. Further, the following condition can be satisfied: 0.50 (1/mm)≤|Cos|≤1.00×10¹⁸ (1/mm).

When the curvature of the out-coupling area corresponding point PO2 is Coc, the following condition can be satisfied: −1.00 (1/mm)≤Coc≤1.00 (1/mm). Further, the following condition can be satisfied: −0.50 (1/mm)≤Coc≤0.50 (1/mm). Further, the following condition can be satisfied: −0.25 (1/mm)≤Coc≤0.25 (1/mm). Further, the following condition can be satisfied: −0.10 (1/mm)≤Coc≤0.10 (1/mm).

When the curvature of the out-coupling area corresponding point PO2 is Coc, the following condition can be satisfied: 0.00 (1/mm)≤|Coc|. Further, the following condition can be satisfied: 0.05 (1/mm)≤|Coc|. Further, the following condition can be satisfied: 0.10 (1/mm)≤|Coc|. Further, the following condition can be satisfied: 0.30 (1/mm)≤|Coc|. Further, the following condition can be satisfied: 0.50 (1/mm)≤|Coc|≤1.00×10¹⁸ (1/mm).

When the curvature radius of the in-coupling area standard point PI1 is Ris, the following condition can be satisfied: −200 mm≤Ris≤200 mm. Further, the following condition can be satisfied: −100 mm≤Ris≤100 mm. Further, the following condition can be satisfied: −50 mm≤Ris≤50 mm. Further, the following condition can be satisfied: −10 mm≤Ris≤10 mm. Further, the following condition can be satisfied: −5 mm≤Ris≤5 mm.

When the curvature radius of the in-coupling area standard point PI1 is Ris, the following condition can be satisfied: |Ris|≤1.00×10¹⁸ mm. Further, the following condition can be satisfied: |Ris|≤500 mm. Further, the following condition can be satisfied: |Ris|≤100 mm. Further, the following condition can be satisfied: |Ris|≤10 mm. Further, the following condition can be satisfied: 0 mm<|Ris|≤3 mm.

When a curvature radius of the in-coupling area corresponding point PI2 is Ric, the following condition can be satisfied: −200 mm≤Ric≤200 mm. Further, the following condition can be satisfied: −100 mm≤Ric≤100 mm. Further, the following condition can be satisfied: −50 mm≤Ric≤50 mm. Further, the following condition can be satisfied: −10 mm≤Ric≤10 mm. Further, the following condition can be satisfied: −5 mm≤Ric≤5 mm.

When the curvature radius of the in-coupling area corresponding point PI2 is Ric, the following condition can be satisfied: |Ric|≤1.00×10¹$ mm. Further, the following condition can be satisfied: |Ric|≤500 mm. Further, the following condition can be satisfied: |Ric|≤100 mm. Further, the following condition can be satisfied: |Ric|≤10 mm. Further, the following condition can be satisfied: 0 mm<|Ric|≤3 mm.

When the curvature radius of the out-coupling area standard point PO1 is Ros, the following condition can be satisfied: −200 mm≤Ros≤200 mm. Further, the following condition can be satisfied: −100 mm≤Ros≤100 mm. Further, the following condition can be satisfied: −50 mm≤Ros≤50 mm. Further, the following condition can be satisfied: −10 mm≤Ros≤10 mm. Further, the following condition can be satisfied: −5 mm≤Ros≤5 mm.

When the curvature radius of the out-coupling area standard point PO1 is Ros, the following condition can be satisfied: |Ros|≤1.00×10¹⁸ mm. Further, the following condition can be satisfied: |Ros|≤500 mm. Further, the following condition can be satisfied: |Ros|≤100 mm. Further, the following condition can be satisfied: |Ros|≤10 mm. Further, the following condition can be satisfied: 0 mm<|Ros|≤3 mm.

When a curvature radius of the out-coupling area corresponding point PO2 is Roc, the following condition can be satisfied: −200 mm≤Roc≤200 mm. Further, the following condition can be satisfied: −100 mm≤Roc≤100 mm. Further, the following condition can be satisfied: −50 mm≤Roc≤50 mm. Further, the following condition can be satisfied: −10 mm≤Roc≤10 mm. Further, the following condition can be satisfied: −5 mm≤Roc≤5 mm.

When the curvature radius of the out-coupling area corresponding point PO2 is Roc, the following condition can be satisfied: |Roc|≤1.00×10¹$ mm. Further, the following condition can be satisfied: |Roc|≤500 mm. Further, the following condition can be satisfied: |Roc|≤100 mm. Further, the following condition can be satisfied: |Roc|≤10 mm. Further, the following condition can be satisfied: 0 mm<|Roc|≤3 mm.

The optical waveguide plate can further include a plastic lens element (not shown), wherein the plastic lens element can be disposed on a front side of the front surface 110a of the optical waveguide plate, and an air spacing is located between the plastic lens element and the front surface 110a of the optical waveguide plate. Therefore, the chromatic aberration formed by the external image passing the optical waveguide plate can be corrected. In particular, the plastic lens element can be attached on the front surface 110a of the optical waveguide plate, or the air spacing is located between the plastic lens element and the front surface 110a of the optical waveguide plate. Further, a front of the front surface 110a of the optical waveguide plate is a side away from the user's eye E.

It should be mentioned that all of the aforementioned parameters and the aforementioned definitions of the optical waveguide plate, such as the front surface, the back surface, the in-coupling area, the out-coupling area, the in-coupling area standard point, the out-coupling area standard point, the standard connecting line, the corresponding connecting line, the length of the out-coupling area, the axial direction, the curvature, the surface shape, the thickness, are based on the optical waveguide plate when the user wears under the condition of the horizontal section of the binocular eye level.

Each of the aforementioned features of the optical system can be utilized in various combinations for achieving the corresponding effects.

The present disclosure provides a composite optical system, which includes at least two of the aforementioned optical systems. Therefore, the area of the out-coupling area can be enhanced so as to expand the viewing angle of the optical systems. In detail, the composite optical system includes at least two groups of the in-coupling elements and the out-coupling elements, wherein the curvature, the thickness, the length and the surface shape of each of the optical systems are independently calculated.

The present disclosure provides a near-eye display apparatus, which includes the aforementioned optical system and an outer cover carrier, wherein the optical system is disposed in the outer cover carrier. Furthermore, the near-eye display apparatus can have at least one metasurface, and the metasurface can be a composite achromatic metasurface. Hence, the metasurface is favorable for reducing the image chromatic aberration, and the composite achromatic metasurface is favorable for further reducing the image chromatic aberration.

In particular, the metasurface can be an achromatic metasurface or an imaging metasurface, wherein the achromatic metasurface has the different metasurface structures and correction bands according to the different designs. For example, the composite achromatic metasurface can have at least three kinds of the metasurface structures so as to correct the different wavelengths, and the correction bands do not overlap. Further, the different metasurface structures can be disposed on the same plane or the different planes, and the multiple metasurface structures can be disposed on the same plane, or the multiple metasurface structures can be disposed on the different planes, wherein the planes of the multiple metasurface structures can be parallel to each other, and the air spacing can be located between the planes of each of the metasurface structures. Or, there is no air spacing located between the planes of each of the metasurface structures. The metasurface can be disposed on the side of the in-coupling element close to the air, the side of the out-coupling element close to the air, the opposite surface of the front surface or the back surface of the optical waveguide plate disposing the in-coupling element, the opposite surface of the front surface or the back surface of the optical waveguide plate disposing the out-coupling element, the image providing device, the image surface or the lens surface of the near-eye display apparatus, but the present disclosure is not limited thereto.

The outer cover carrier is configured to carry the optical system and another elements, wherein the appearance of the outer cover carrier can be a pair of glasses, an eyeshield, a pair of windshields, a pair of goggles, a pair of swimming goggles, a pair of ski goggles, a helmet or a safety helmet, but the present disclosure is not limited thereto.

Moreover, the near-eye display apparatus can further include a mother board (MB), a central processing unit (CPU), a digital signal processor (DSP), a graphics processing unit (GPU), a micro processer unit (MPU), a micro control unit (MCU), an inertial measurement unit (IMU), a storage unit or a hardware, a memory, a near-field communication (NFC) device, a camera, an auto focus (AF) device, a time of flight (ToF) sensor, a vertical-cavity surface-emitting laser (VCSEL), an iris recognition device, a battery, a power supply, a projecting lens, a collimation lens, a dodging lens, a vision correction lens, a light shield, a pair of earphones, a microphone and any combination of the aforementioned elements. Further, each of the aforementioned elements can have different numbers according to the requirements, and the number of each of the aforementioned elements can be at least one, at least two, at least three, at least four, at least five, at least six, at least seven, at least eight, at least nine, at least ten, at least eleven, at least twelve, at least thirteen, at least fourteen, at least fifteen or at least sixteen, but the present disclosure is not limited thereto.

Moreover, the near-eye display apparatus can further include an anti-reflection coatings (ARCs) so as to prevent the stray light and the ghost image formed via the reflection of the light, wherein the anti-reflection coatings can be a subwavelength structure, the anti-reflection coatings can be disposed on a full surface of the projecting lens, a partial surface of the projecting lens, a full surface of the collimation lens, a partial surface of the collimation lens, a full surface of the dodging lens, a partial surface of the dodging lens, a full surface of the optical waveguide plate or a partial surface of the optical waveguide plate. The near-eye display apparatus can further include a thermal dissipation coating so as to control the temperature of the near-eye display apparatus, wherein the thermal dissipation coating can be a graphene coating or a diamond-like carbon coating, and the thermal dissipation coating can be disposed on the mother board, the central processing unit, the digital signal processor, the graphics processing unit, the micro processer unit, the micro control unit, the inertial measurement unit, the storage unit, the hardware, the memory, the near-field communication device, the camera, the auto focus device, the time of flight sensor, the vertical-cavity surface-emitting laser, the iris recognition device, the battery, the surface of the power supply or the contact surface between the aforementioned elements, and the thermal dissipation coating can be also disposed on the internal surface or the external surface of the outer cover carrier, but the present disclosure is not limited thereto.

The near-eye display apparatus can achieve the multiple functions by disposing the different numbers of the aforementioned elements, such as the 3 DoF (Degree of Freedom), 6 DoF (Degree of Freedom), the time of flight, the facial recognition, the expression recognition, the fingerprint recognition, the auto focus, the eye dynamic tracking, the gesture tracking and recognition, the distance sensing, the spatial positioning, capturing the image, the photography, the external image real-time display, the object scanning, the remote operation, the blood pressure sensing, the heartbeat sensing, the internet access, the electronic payment, the EasyCard payment, the text messaging, the voice communication and video, the software editing, the input and output of the video, the note writing, the drawing, AR, VR and a mixed reality (MR).

In detail, the structure of the near-eye display apparatus can be integrated or non-integrated. That is, the near-eye display apparatus can be integrally formed or non-integrally formed. When the structure of the near-eye display apparatus is integrated, the near-eye display apparatus can have the independent computing ability which can usually cooperate with the central processing unit, the digital signal processor, the graphics processing unit, the micro processer unit, the micro control unit or the inertial measurement unit. When the structure of the near-eye display apparatus is non-integrated which usually does not obtain the independent computing ability or obtains the incomplete computing ability, the external device including the processor is required.

The near-eye display apparatus is usually equipped with the battery or the power supply, wherein the external power supply is not usually required when the near-eye display apparatus equipped with the battery is used, and the external power supply is usually required when the near-eye display apparatus equipped with the power supply is used. When the near-eye display apparatus is equipped with the battery, the near-eye display apparatus can be charged via the wired connection or the wireless induction. When the near-eye display apparatus includes the storage element or the hardware, the data can be transmitted via the wired connection or the wireless connection, wherein the wireless connection can be the infrared, the 2.4G frequency band or the 5G frequency band, but the present disclosure is not limited thereto.

Moreover, the near-eye display apparatus can be wiredly or wirelessly connected to a peripheral apparatus, and the peripheral apparatus can include a joystick, a controller, a handle grip, a pair of earphones, a mouse, a keyboard, a pen and a wearable device, wherein the wearable device can be a garment, a pair of pants, a pair of shoes, a wristband, an armband, a belt, a bracelet or a pair of gloves.

The near-eye display apparatus can be wiredly or wirelessly connected to a connecting device, wherein the connecting device can be a desktop computer host, a laptop, a cell phone, a tablet or a television, but the present disclosure is not limited thereto.

Each of the aforementioned features of the near-eye display apparatus can be utilized in various combinations for achieving the corresponding effects.

According to the aforementioned embodiment, specific examples are provided, and illustrated via figures.

### 1St Example

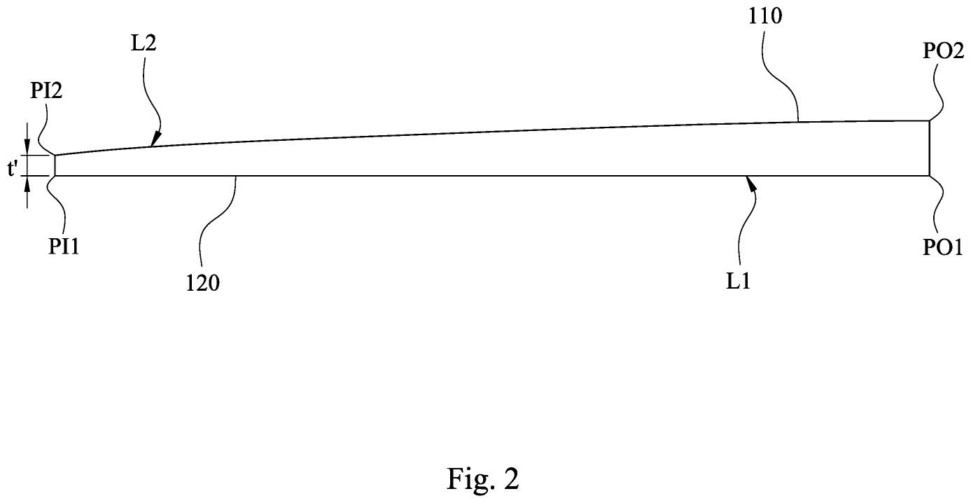

FIG. 2 is a partial schematic view of an optical waveguide plate according to the 1st example of the present disclosure. In FIG. 2, the optical waveguide plate (its reference numeral is omitted) has a front surface 110 and a back surface 120, and includes an in-coupling element (not shown) and an out-coupling element (not shown), wherein the in-coupling element and the out-coupling element are disposed on the back surface 120, an in-coupling area (its reference numeral is omitted) is an area of the back surface 120 on which the in-coupling element is disposed, and an out-coupling area (its reference numeral is omitted) is an area of the back surface 120 on which the out-coupling element is disposed. Further, a thickness of the optical waveguide plate is gradually increased from the in-coupling area towards the out-coupling area, the front surface 110 of the optical waveguide plate is an aspheric surface, and the back surface 120 of the optical waveguide plate is a plane. It should be mentioned that FIG. 2 is the schematic view of the optical waveguide plate when the user wears under the condition of the horizontal section of the binocular eye level.

The in-coupling area has an in-coupling area standard point PI1, and the out-coupling area has an out-coupling area standard point PO1. Further, an in-coupling area corresponding point PI2 is an intersection of the in-coupling area standard point PI1 from the back surface 120 on which the in-coupling element is disposed extending towards the front surface 110 along a normal line. An out-coupling area corresponding point PO2 is an intersection of the out-coupling area standard point PO1 from the back surface 120 on which the out-coupling element is disposed extending towards the front surface 110 along the normal line. In particular, the front surface 110 of the optical waveguide plate has the in-coupling area corresponding point PI2 and the out-coupling area corresponding point PO2, and the back surface 120 of the optical waveguide plate has the in-coupling area standard point PI1 and the out-coupling area standard point PO1.

Moreover, the connection on the same side surface (that is, the back surface 120) between the out-coupling area standard point PO1 and the in-coupling area standard point PI1 is a standard connecting line L1, wherein the out-coupling area standard point PO1 is located on the same side surface (that is, the back surface 120) of the in-coupling area standard point PI1. The connection on the same side surface (that is, the front surface 110) between the out-coupling area corresponding point PO2 and the in-coupling area corresponding point PI2 is a corresponding connecting line L2, wherein the out-coupling area corresponding point PO2 is located on the same side surface (that is, the front surface 110) of the in-coupling area corresponding point PI2.

A curvature radius absolute value of the front surface 110 of the optical waveguide plate is gradually increased from the in-coupling area towards the out-coupling area, a curvature absolute value of the front surface 110 of the optical waveguide plate is gradually decreased from the in-coupling area towards the out-coupling area, a curvature radius absolute value of the back surface 120 of the optical waveguide plate is constant from the in-coupling area towards the out-coupling area, and a curvature absolute value of the back surface 120 of the optical waveguide plate is constant from the in-coupling area towards the out-coupling area.

According to the 1st example, a length of the out-coupling area is W, a thickness of the optical waveguide plate at the out-coupling area standard point PO1 is t, a thickness of the optical waveguide plate at the in-coupling area standard point PI1 is t′, a curvature of the in-coupling area standard point PI1 is Cis, a curvature of the in-coupling area corresponding point PI2 is Cic, a curvature of the out-coupling area standard point PO1 is Cos, a curvature of the out-coupling area corresponding point PO2 is Coc, a curvature radius of the in-coupling area standard point PI1 is Ris, a curvature radius of the in-coupling area corresponding point PI2 is Ric, a curvature radius of the out-coupling area standard point PO1 is Ros, a curvature radius of the out-coupling area corresponding point PO2 is Roc, a refractive index of the optical waveguide plate is N, wherein the length W of the out-coupling area and the thickness t of the optical waveguide plate at the out-coupling area standard point PO1 can be referred to the indications in FIG. 1, the following conditions of Table 1 are satisfied.

TABLE 1

| | | | |
|---|---|---|---|
| W (mm) | 2.40 | Coc (1/mm) | −0.08 |
| t (mm) | 2.00 | \|Coc\| (1/mm) | 0.08 |
| W/2t | 0.60 | Ris (mm) | 1 × 10¹⁸ |
| N | 1.80 | \|Ris\| (mm) | 1 × 10¹⁸ |
| t′ (mm) | 0.75 | Ric (mm) | −1.04 |
| Cis (1/mm) | 0 | \|Ric\| (mm) | 1.04 |
| \|Cis\| (1/mm) | 0 | Ros (mm) | 1 × 10¹⁸ |
| Cic (1/mm) | −0.96 | \|Ros\| (mm) | 1 × 10¹⁸ |
| \|Cic\| (1/mm) | 0.96 | Roc (mm) | −12.22 |
| Cos (1/mm) | 0 | \|Roc\| (mm) | 12.22 |
| \|Cos\| (1/mm) | 0 | | |

It should be mentioned that the thickness t of the optical waveguide plate at the out-coupling area standard point PO1 is the length between the intersection of a measuring point and the front surface 110 of the optical waveguide plate along the normal line and the intersection of the measuring point and the back surface 120 of the optical waveguide plate along the normal line, wherein the measuring point is taken on the standard connecting line L1. The thickness t′ of the optical waveguide plate at the in-coupling area standard point PI1 is the connecting length of the optical waveguide plate between the in-coupling area standard point PI1 and the in-coupling area corresponding point PI2.

### 2nd Example

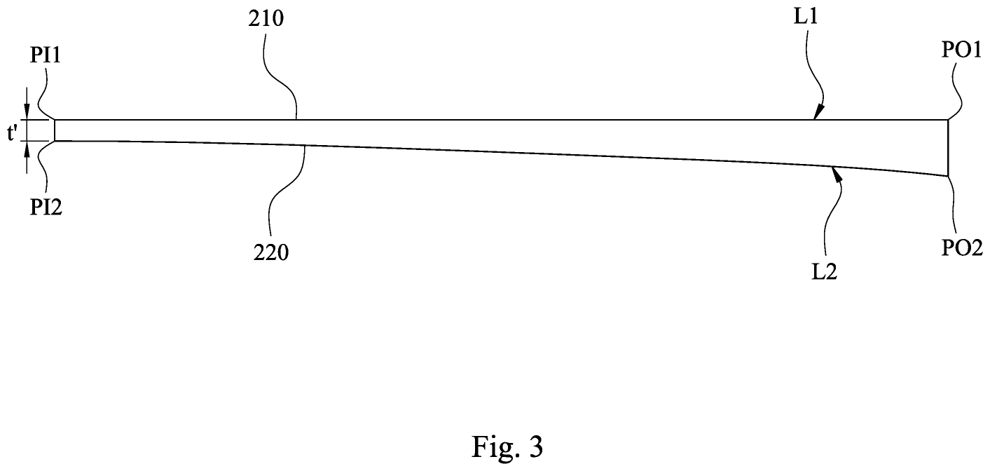

FIG. 3 is a partial cross-section view of an optical waveguide plate according to the 2nd example of the present disclosure. In FIG. 3, the optical waveguide plate (its reference numeral is omitted) has a front surface 210 and a back surface 220, and includes an in-coupling element (not shown) and an out-coupling element (not shown), wherein the in-coupling element and the out-coupling element are disposed on the front surface 210, an in-coupling area (its reference numeral is omitted) is an area of the front surface 210 on which the in-coupling element is disposed, and an out-coupling area (its reference numeral is omitted) is an area of the front surface 210 on which the out-coupling element is disposed. Further, a thickness of the optical waveguide plate is gradually increased from the in-coupling area towards the out-coupling area, the front surface 210 of the optical waveguide plate is a plane, and the back surface 220 of the optical waveguide plate is an aspheric surface. It should be mentioned that FIG. 3 is the schematic view of the optical waveguide plate when the user wears under the condition of the horizontal section of the binocular eye level.

The in-coupling area has an in-coupling area standard point PI1, and the out-coupling area has an out-coupling area standard point PO1. Further, an in-coupling area corresponding point PI2 is an intersection of the in-coupling area standard point PI1 from the front surface 210 on which the in-coupling element is disposed extending towards the back surface 220 along a normal line. An out-coupling area corresponding point PO2 is an intersection of the out-coupling area standard point PO1 from the front surface 210 on which the out-coupling element is disposed extending towards the back surface 220 along the normal line. In particular, the front surface 210 of the optical waveguide plate has the in-coupling area standard point PI1 and the out-coupling area standard point PO1, and the back surface 220 of the optical waveguide plate has the in-coupling area corresponding point PI2 and the out-coupling area corresponding point PO2.

Moreover, the connection on the same side surface (that is, the front surface 210) between the out-coupling area standard point PO1 and the in-coupling area standard point PI1 is a standard connecting line L1, wherein the out-coupling area standard point PO1 is located on the same side surface (that is, the front surface 210) of the in-coupling area standard point PI1. The connection on the same side surface (that is, the back surface 220) between the out-coupling area corresponding point PO2 and the in-coupling area corresponding point PI2 is a corresponding connecting line L2, wherein the out-coupling area corresponding point PO2 is located on the same side surface (that is, the back surface 220) of the in-coupling area corresponding point PI2.

A curvature radius absolute value of the front surface 210 of the optical waveguide plate is constant from the in-coupling area towards the out-coupling area, a curvature absolute value of the front surface 210 of the optical waveguide plate is constant from the in-coupling area towards the out-coupling area, a curvature radius absolute value of the back surface 220 of the optical waveguide plate is gradually decreased from the in-coupling area towards the out-coupling area, and a curvature absolute value of the back surface 220 of the optical waveguide plate is gradually increased from the in-coupling area towards the out-coupling area.

According to the 2nd example, a length of the out-coupling area is W, a thickness of the optical waveguide plate at the out-coupling area standard point PO1 is t, a thickness of the optical waveguide plate at the in-coupling area standard point PI1 is t′, a curvature of the in-coupling area standard point PI1 is Cis, a curvature of the in-coupling area corresponding point PI2 is Cic, a curvature of the out-coupling area standard point PO1 is Cos, a curvature of the out-coupling area corresponding point PO2 is Coc, a curvature radius of the in-coupling area standard point PI1 is Ris, a curvature radius of the in-coupling area corresponding point PI2 is Ric, a curvature radius of the out-coupling area standard point PO1 is Ros, a curvature radius of the out-coupling area corresponding point PO2 is Roc, a refractive index of the optical waveguide plate is N, wherein the length W of the out-coupling area and the thickness t of the optical waveguide plate at the out-coupling area standard point PO1 can be referred to the indications in FIG. 1, the following conditions of Table 2 are satisfied.

TABLE 2

| | | | |
|---|---|---|---|
| W (mm) | 5.20 | Coc (1/mm) | 0.96 |
| t (mm) | 2.10 | \|Coc\| (1/mm) | 0.96 |
| W/2t | 1.24 | Ris (mm) | 1 × 10¹⁸ |
| N | 1.90 | \|Ris\| (mm) | 1 × 10¹⁸ |
| t′ (mm) | 0.79 | Ric (mm) | 12.22 |
| Cis (1/mm) | 0 | \|Ric\| (mm) | 12.22 |
| \|Cis\| (1/mm) | 0 | Ros (mm) | 1 × 10¹⁸ |
| Cic (1/mm) | 0.08 | \|Ros\| (mm) | 1 × 10¹⁸ |
| \|Cic\| (1/mm) | 0.08 | Roc (mm) | 1.04 |
| Cos (1/mm) | 0 | \|Roc\| (mm) | 1.04 |
| \|Cos\| (1/mm) | 0 | | |

It should a mentioned that the thickness of optical waveguide plate at the out-coupling area standard point PO1 is the length between the intersection of a measuring point and the front surface 210 of the optical waveguide plate along the normal line and the intersection of the measuring point and the back surface 220 of the optical waveguide plate along the normal line, wherein the measuring point is taken on the standard connecting line L1. The thickness t′ of the optical waveguide plate at the in-coupling area standard point PI1 is the connecting length of the optical waveguide plate between the in-coupling area standard point PI1 and the in-coupling area corresponding point PI2.

### 3rd Example

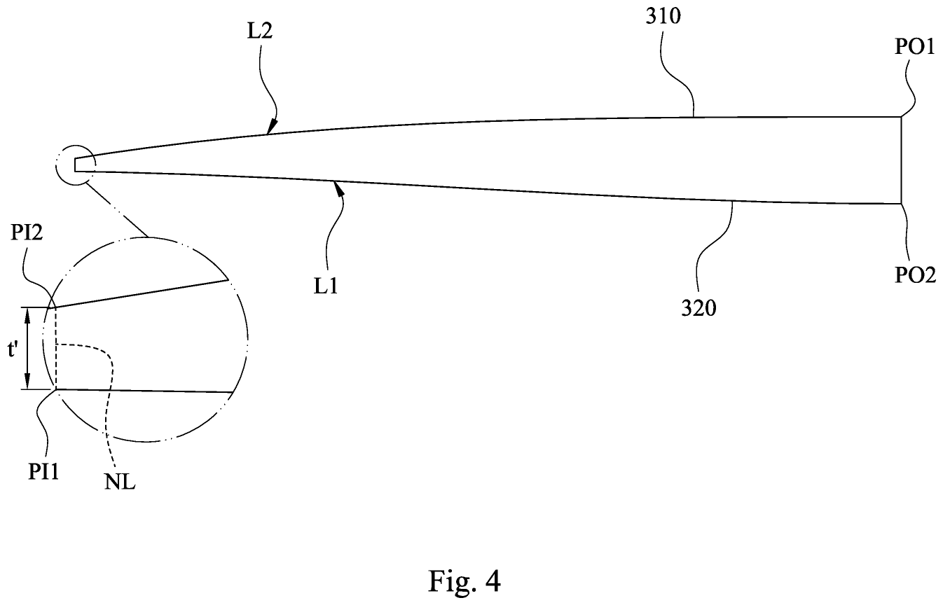

FIG. 4 is a partial cross-section view of an optical waveguide plate according to the 3rd example of the present disclosure. In FIG. 4, the optical waveguide plate (its reference numeral is omitted) has a front surface 310 and a back surface 320, and includes an in-coupling element (not shown) and an out-coupling element (not shown), wherein the in-coupling element is disposed on the back surface 320, the out-coupling element is disposed on the front surface 310, an in-coupling area (its reference numeral is omitted) is an area of the back surface 320 on which the in-coupling element is disposed, and an out-coupling area (its reference numeral is omitted) is an area of the front surface 310 on which the out-coupling element is disposed. Further, a thickness of the optical waveguide plate is gradually increased from the in-coupling area towards the out-coupling area, the front surface 310 of the optical waveguide plate is an aspheric surface, and the back surface 320 of the optical waveguide plate is an aspheric surface. It should be mentioned that FIG. 4 is the schematic view of the optical waveguide plate when the user wears under the condition of the horizontal section of the binocular eye level.

The in-coupling area has an in-coupling area standard point PI1, and the out-coupling area has an out-coupling area standard point PO1. Further, an in-coupling area corresponding point PI2 is an intersection of the in-coupling area standard point PI1 from the back surface 320 on which the in-coupling element is disposed extending towards the front surface 310 along a normal line NL. An out-coupling area corresponding point PO2 is an intersection of the out-coupling area standard point PO1 from the front surface 310 on which the out-coupling element is disposed extending towards the back surface 320 along the normal line NL. In particular, the front surface 310 of the optical waveguide plate has the in-coupling area corresponding point PI2 and the out-coupling area standard point PO1, and the back surface 320 of the optical waveguide plate has the in-coupling area standard point PI1 and the out-coupling area corresponding point PO2.

Moreover, the connection on the same side surface (that is, the back surface 320) between the out-coupling area corresponding point PO2 and the in-coupling area standard point PI1 is a standard connecting line L1, wherein the out-coupling area corresponding point PO2 is located on the same side surface (that is, the back surface 320) of the in-coupling area standard point PI1. The connection on the same side surface (that is, the front surface 310) between the out-coupling area standard point PO1 and the in-coupling area corresponding point PI2 is a corresponding connecting line L2, wherein the out-coupling area standard point PO1 is located on the same side surface (that is, the front surface 310) of the in-coupling area corresponding point PI2.

A curvature radius absolute value of the front surface 310 of the optical waveguide plate is gradually increased from the in-coupling area towards the out-coupling area, a curvature absolute value of the front surface 310 of the optical waveguide plate is gradually decreased from the in-coupling area towards the out-coupling area, a curvature radius absolute value of the back surface 320 of the optical waveguide plate is gradually increased from the in-coupling area towards the out-coupling area, and a curvature absolute value of the back surface 320 of the optical waveguide plate is gradually decreased from the in-coupling area towards the out-coupling area.

According to the 3rd example, a length of the out-coupling area is W, a thickness of the optical waveguide plate at the out-coupling area standard point PO1 is t, a thickness of the optical waveguide plate at the in-coupling area standard point PI1 is t′, a curvature of the in-coupling area standard point PI1 is Cis, a curvature of the in-coupling area corresponding point PI2 is Cic, a curvature of the out-coupling area standard point PO1 is Cos, a curvature of the out-coupling area corresponding point PO2 is Coc, a curvature radius of the in-coupling area standard point PI1 is Ris, a curvature radius of the in-coupling area corresponding point PI2 is Ric, a curvature radius of the out-coupling area standard point PO1 is Ros, a curvature radius of the out-coupling area corresponding point PO2 is Roc, a refractive index of the optical waveguide plate is N, wherein the length W of the out-coupling area and the thickness t of the optical waveguide plate at the out-coupling area standard point PO1 can be referred to the indications in FIG. 1, the following conditions of Table 3 are satisfied.

TABLE 3

| | | | |
|---|---|---|---|
| W (mm) | 45.00 | Coc (1/mm) | 0.15 |
| t (mm) | 7.00 | \|Coc\| (1/mm) | 0.15 |
| W/2t | 3.21 | Ris (mm) | 3.06 |
| N | 2.00 | \|Ris\| (mm) | 3.06 |
| t′ (mm) | 1.04 | Ric (mm) | −3.70 |
| Cis (1/mm) | 0.33 | \|Ric\| (mm) | 3.70 |
| \|Cis\| (1/mm) | 0.33 | Ros (mm) | −66.97 |
| Cic (1/mm) | −0.27 | \|Ros\| (mm) | 66.97 |
| \|Cic\| (1/mm) | 0.27 | Roc (mm) | 6.63 |
| Cos (1/mm) | −0.01 | \|Roc\| (mm) | 6.63 |
| \|Cos\| (1/mm) | 0.01 | | |

It should be mentioned that the thickness t of the optical waveguide plate at the out-coupling area standard point PO1 is the length between the intersection of a measuring point and the front surface 310 of the optical waveguide plate along the normal line NL and the intersection of the measuring point and the back surface 320 of the optical waveguide plate along the normal line NL, wherein the measuring point is taken on the standard connecting line U. The thickness t′ of the optical waveguide plate at the in-coupling area standard point PI1 is the connecting length of the optical waveguide plate between the in-coupling area standard point PI1 and the in-coupling area corresponding point PI2.

### 4th Example

According to the 4th example, the optical waveguide plate has a front surface and a back surface, and includes an in-coupling element and an out-coupling element, wherein the in-coupling element is disposed on the front surface, the out-coupling element is disposed on the front surface, an in-coupling area is an area of the front surface on which the in-coupling element is disposed, and an out-coupling area is an area of the front surface on which the out-coupling element is disposed. Further, a thickness of the optical waveguide plate is gradually increased from the in-coupling area towards the out-coupling area, the front surface of the optical waveguide plate is an aspheric surface, and the back surface of the optical waveguide plate is a plane. It should be mentioned that the schematic view of the optical waveguide plate according to the 4th example can be referred to FIGS. 2 to 4.

The in-coupling area has an in-coupling area standard point, and the out-coupling area has an out-coupling area standard point. Further, an in-coupling area corresponding point is an intersection of the in-coupling area standard point from the front surface on which the in-coupling element is disposed extending towards the back surface along a normal line. An out-coupling area corresponding point is an intersection of the out-coupling area standard point from the front surface on which the out-coupling element is disposed extending towards the back surface along the normal line. In particular, the front surface of the optical waveguide plate has the in-coupling area standard point and the out-coupling area standard point, and the back surface of the optical waveguide plate has the in-coupling area corresponding point and the out-coupling area corresponding point.

Moreover, the connection on the same side surface (that is, the front surface) between the out-coupling area standard point and the in-coupling area standard point is a standard connecting line, wherein the out-coupling area standard point is located on the same side surface (that is, the front surface) of the in-coupling area standard point. The connection on the same side surface (that is, the back surface) between the out-coupling area corresponding point and the in-coupling area corresponding point is a corresponding connecting line, wherein the out-coupling area corresponding point is located on the same side surface (that is, the back surface) of the in-coupling area corresponding point.

A curvature radius absolute value of the front surface of the optical waveguide plate is gradually increased from the in-coupling area towards the out-coupling area, a curvature absolute value of the front surface of the optical waveguide plate is gradually decreased from the in-coupling area towards the out-coupling area, a curvature radius absolute value of the back surface of the optical waveguide plate is constant from the in-coupling area towards the out-coupling area, and a curvature absolute value of the back surface of the optical waveguide plate is constant from the in-coupling area towards the out-coupling area.

A length of the out-coupling area is W, a thickness of the optical waveguide plate at the out-coupling area standard point is t, a thickness of the optical waveguide plate at the in-coupling area standard point is t′, a curvature of the in-coupling area standard point is Cis, a curvature of the in-coupling area corresponding point is Cic, a curvature of the out-coupling area standard point is Cos, a curvature of the out-coupling area corresponding point is Coc, a curvature radius of the in-coupling area standard point is Ris, a curvature radius of the in-coupling area corresponding point is Ric, a curvature radius of the out-coupling area standard point is Ros, a curvature radius of the out-coupling area corresponding point is Roc, a refractive index of the optical waveguide plate is N, wherein the length W of the out-coupling area and the thickness t of the optical waveguide plate at the out-coupling area standard point can be referred to the indications in FIG. 1, the following conditions of Table 4 are satisfied.

TABLE 4

| | | | |
|---|---|---|---|
| W (mm) | 2.80 | Coc (1/mm) | 0 |
| t (mm) | 1.40 | \|Coc\| (1/mm) | 0 |
| W/2t | 1.00 | Ris (mm) | −1.04 |
| N | 1.85 | \|Ris\| (mm) | 1.04 |
| t′ (mm) | 0.52 | Ric (mm) | 1.00 × 10¹⁸ |
| Cis (1/mm) | −0.96 | \|Ric\| (mm) | 1.00 × 10¹⁸ |
| \|Cis\| (1/mm) | 0.96 | Ros (mm) | −12.22 |
| Cic (1/mm) | 0 | \|Ros\| (mm) | 12.22 |
| \|Cic\| (1/mm) | 0 | Roc (mm) | 1.00 × 10¹⁸ |
| Cos (1/mm) | −0.08 | \|Roc\| (mm) | 1.00 × 10¹⁸ |
| \|Cos\| (1/mm) | 0.08 | | |

It should be mentioned that the thickness t of the optical waveguide plate at the out-coupling area standard point is the length between the intersection of a measuring point and the front surface of the optical waveguide plate along the normal line and the intersection of the measuring point and the back surface of the optical waveguide plate along the normal line, wherein the measuring point is taken on the standard connecting line. The thickness t′ of the optical waveguide plate at the in-coupling area standard point is the connecting length of the optical waveguide plate between the in-coupling area standard point and the in-coupling area corresponding point.

### 5th Example

According to the 5th example, the optical waveguide plate has a front surface and a back surface, and includes an in-coupling element and an out-coupling element, wherein the in-coupling element is disposed on the back surface, the out-coupling element is disposed on the back surface, an in-coupling area is an area of the back surface on which the in-coupling element is disposed, and an out-coupling area is an area of the back surface on which the out-coupling element is disposed. Further, a thickness of the optical waveguide plate is gradually increased from the in-coupling area towards the out-coupling area, the front surface of the optical waveguide plate is a plane, and the back surface of the optical waveguide plate is an aspheric surface. It should be mentioned that the schematic view of the optical waveguide plate according to the 5th example can be referred to FIGS. 2 to 4.

The in-coupling area has an in-coupling area standard point, and the out-coupling area has an out-coupling area standard point. Further, an in-coupling area corresponding point is an intersection of the in-coupling area standard point from the back surface on which the in-coupling element is disposed extending towards the front surface along a normal line. An out-coupling area corresponding point is an intersection of the out-coupling area standard point from the back surface on which the out-coupling element is disposed extending towards the front surface along the normal line. In particular, the back surface of the optical waveguide plate has the in-coupling area standard point and the out-coupling area standard point, and the front surface of the optical waveguide plate has the in-coupling area corresponding point and the out-coupling area corresponding point.

Moreover, the connection on the same side surface (that is, the back surface) between the out-coupling area standard point and the in-coupling area standard point is a standard connecting line, wherein the out-coupling area standard point is located on the same side surface (that is, the back surface) of the in-coupling area standard point. The connection on the same side surface (that is, the front surface) between the out-coupling area corresponding point and the in-coupling area corresponding point is a corresponding connecting line, wherein the out-coupling area corresponding point is located on the same side surface (that is, the front surface) of the in-coupling area corresponding point.

A curvature radius absolute value of the front surface of the optical waveguide plate is constant from the in-coupling area towards the out-coupling area, a curvature absolute value of the front surface of the optical waveguide plate is constant from the in-coupling area towards the out-coupling area, a curvature radius absolute value of the back surface of the optical waveguide plate is gradually decreased from the in-coupling area towards the out-coupling area, and a curvature absolute value of the back surface of the optical waveguide plate is gradually increased from the in-coupling area towards the out-coupling area.

A length of the out-coupling area is W, a thickness of the optical waveguide plate at the out-coupling area standard point is t, a thickness of the optical waveguide plate at the in-coupling area standard point is t′, a curvature of the in-coupling area standard point is Cis, a curvature of the in-coupling area corresponding point is Cic, a curvature of the out-coupling area standard point is Cos, a curvature of the out-coupling area corresponding point is Coc, a curvature radius of the in-coupling area standard point is Ris, a curvature radius of the in-coupling area corresponding point is Ric, a curvature radius of the out-coupling area standard point is Ros, a curvature radius of the out-coupling area corresponding point is Roc, a refractive index of the optical waveguide plate is N, wherein the length W of the out-coupling area and the thickness t of the optical waveguide plate at the out-coupling area standard point can be referred to the indications in FIG. 1, the following conditions of Table 5 are satisfied.

TABLE 5

| | | | |
|---|---|---|---|
| W (mm) | 7.00 | Coc (1/mm) | 0 |
| t (mm) | 1.80 | \|Coc\| (1/mm) | 0 |
| W/2t | 1.94 | Ris (mm) | 12.22 |
| N | 1.95 | \|Ris\| (mm) | 12.22 |
| t′ (mm) | 0.68 | Ric (mm) | 1.00 × 10¹⁸ |
| Cis (1/mm) | 0.08 | \|Ric\| (mm) | 1.00 × 10¹⁸ |
| \|Cis\| (1/mm) | 0.08 | Ros (mm) | 1.04 |
| Cic (1/mm) | 0 | \|Ros\| (mm) | 1.04 |
| \|Cic\| (1/mm) | 0 | Roc (mm) | 1.00 × 10¹⁸ |
| Cos (1/mm) | 0.96 | \|Roc\| (mm) | 1.00 × 10¹⁸ |
| \|Cos\| (1/mm) | 0.96 | | |

It should be mentioned that the thickness t of the optical waveguide plate at the out-coupling area standard point is the length between the intersection of a measuring point and the front surface of the optical waveguide plate along the normal line and the intersection of the measuring point and the back surface of the optical waveguide plate along the normal line, wherein the measuring point is taken on the standard connecting line. The thickness t′ of the optical waveguide plate at the in-coupling area standard point is the connecting length of the optical waveguide plate between the in-coupling area standard point and the in-coupling area corresponding point.

### 6th Example

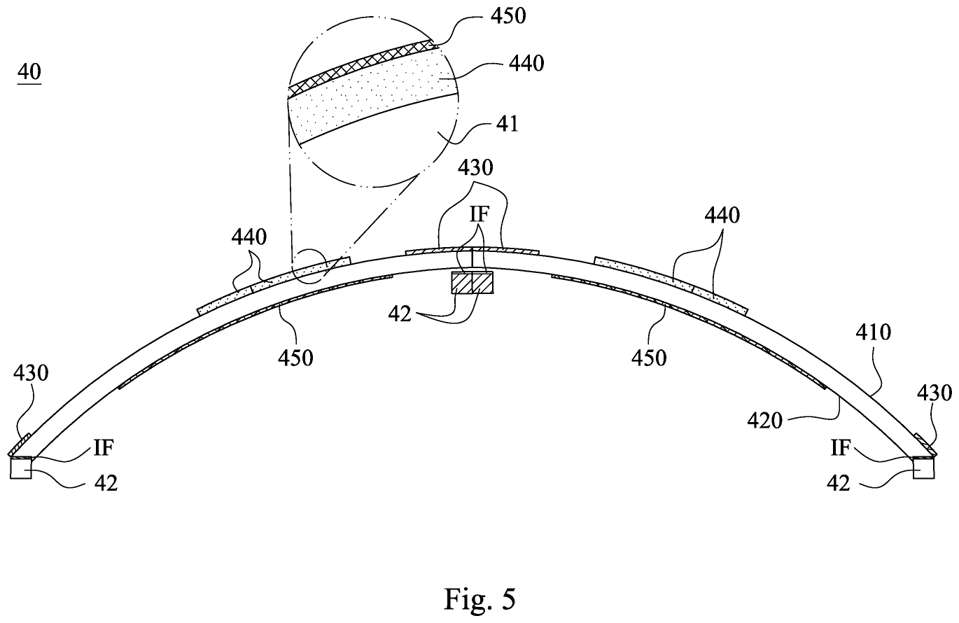

FIG. 5 is a schematic view of a composite optical system 40 according to the 6th example of the present disclosure. In FIG. 5, the composite optical system 40 includes two optical systems (their reference numerals are omitted), wherein each of the optical systems includes an optical waveguide plate (its reference numeral is omitted) and two image providing devices 42, and the image providing devices 42 are disposed on a back side of the optical waveguide plate. It should be mentioned that the composite optical system 40 is a shared optical waveguide plate. According to the 6th example, the optical waveguide plate can be the optical waveguide plate according to the aforementioned 1st example to the 5th example, but the present disclosure is not limited thereto.

The optical waveguide plate has a front surface 410 and a back surface 420, and includes two in-coupling elements 430 and two out-coupling elements 440, wherein the in-coupling elements 430 and the out-coupling elements 440 are disposed on the front surface 410, an in-coupling area (its reference numeral is omitted) is an area of the front surface 410 on which the in-coupling elements 430 are disposed, and an out-coupling area (its reference numeral is omitted) is an area of the front surface 410 on which the out-coupling elements 440 are disposed. Further, a thickness of the optical waveguide plate is gradually increased from the in-coupling area towards the out-coupling area, and at least one of the front surface 410 and the back surface 420 is a curved surface, and the curved surface is an aspheric surface.

The optical waveguide plate can further include a plastic lens element (not shown), wherein the plastic lens element can be disposed on a front side of the front surface 410 of the optical waveguide plate, and an air spacing is located between the plastic lens element and the front surface 410 of the optical waveguide plate.

The composite optical system 40 further has four metasurfaces 450, wherein two of the metasurfaces 450 are disposed on the back surface 420, and the other two of the metasurfaces 450 are disposed on the out-coupling elements 440. That is, the out-coupling elements 440 are located between the metasurfaces 450 and a surface 41 of the optical waveguide plate. Further, each of the metasurfaces 450 can be a composite achromatic metasurface.

Moreover, an image surface IF is located on each of the image providing devices 42, and the image surface emitting light is provided via the image surface IF, wherein the image surface emitting light provided via the image surface IF can be guided in the optical waveguide plate or the image surface emitting light can be transformed into the total internal reflecting light via the in-coupling elements 430, and the image surface emitting light provided via the image surface IF can be guided out the optical waveguide plate or the image surface emitting light can be transformed into the non-total internal reflecting light via the out-coupling elements 440.

### 7th Example

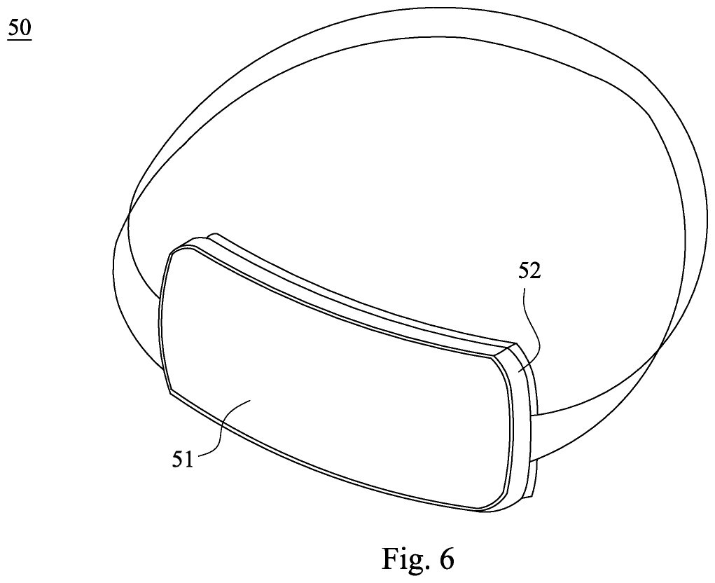

FIG. 6 is a schematic view of a near-eye display apparatus 50 according to the 7th example of the present disclosure. In FIG. 6, the near-eye display apparatus 50 includes an optical system 51 and an outer cover carrier 52, wherein the optical system 51 is disposed in the outer cover carrier 52, the optical system 51 includes an optical waveguide plate (not shown) and an image providing device (not shown), and the image providing device is disposed on a front side or a back side of the optical waveguide plate.

According to the 7th example, the optical waveguide plate can be the optical waveguide plate according to the aforementioned 1st example to the 5th example, but the present disclosure is not limited thereto.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

What is claimed is:

1. An optical waveguide plate, having a front surface and a back surface, and comprising:
an in-coupling element; and
an out-coupling element;
wherein the in-coupling element and the out-coupling element are disposed on at least one of the front surface and the back surface;
wherein an in-coupling area is an area of the at least one of the front surface and the back surface on which the in-coupling element is disposed, and an out-coupling area is an area of the at least one of the front surface and the back surface on which the out-coupling element is disposed;
wherein a thickness of the optical waveguide plate is gradually increased from the in-coupling area towards the out-coupling area.

2. The optical waveguide plate of claim 1, wherein at least one of the front surface and the back surface of the optical waveguide plate is a curved surface.

3. The optical waveguide plate of claim 2, wherein the curved surface is an aspheric surface.

4. The optical waveguide plate of claim 2, wherein the front surface of the optical waveguide plate has an in-coupling area standard point or an in-coupling area corresponding point, and a curvature of the in-coupling area standard point or a curvature of the in-coupling area corresponding point of the front surface of the optical waveguide plate is a negative value.

5. The optical waveguide plate of claim 2, wherein the back surface of the optical waveguide plate has an in-coupling area standard point or an in-coupling area corresponding point, and a curvature of the in-coupling area standard point or a curvature of the in-coupling area corresponding point of the back surface of the optical waveguide plate is a positive value.

6. The optical waveguide plate of claim 4, wherein a curvature absolute value of the front surface of the optical waveguide plate from the in-coupling area towards the out-coupling area is gradually decreased.

7. The optical waveguide plate of claim 5, wherein a curvature absolute value of the back surface of the optical waveguide plate from the in-coupling area towards the out-coupling area is gradually decreased.

8. The optical waveguide plate of claim 1, wherein a refractive index of the optical waveguide plate is N, and the following condition is satisfied:
$$1.8 \leq N .$$

9. The optical waveguide plate of claim 1, wherein the out-coupling area has an out-coupling area standard point, a length of the out-coupling area is W, a thickness of the optical waveguide plate at the out-coupling area standard point is t, and the following condition is satisfied:
$$0.57 \leq W / 2 t \leq 1.00 \times 1 {0}^{18} .$$

10. The optical waveguide plate of claim 1, wherein at least one of the in-coupling element and the out-coupling element is a holographic grating.

11. An optical system, comprising:
the optical waveguide plate of claim 1; and
an image providing device disposed on a front side or a back side of the optical waveguide plate.

12. The optical system of claim 11, wherein the optical waveguide plate further comprises a plastic lens element, the plastic lens element is disposed on a front side of the front surface, and an air spacing is located between the plastic lens element and the front surface of the optical waveguide plate.

13. A composite optical system, comprising:
at least two of the optical systems of claim 11.

14. A near-eye display apparatus, comprising:
the optical system of claim 11; and
an outer cover carrier, wherein the optical system is disposed in the outer cover carrier.

15. An optical waveguide plate, having a front surface and a back surface, and comprising:
an in-coupling element; and
an out-coupling element;
wherein the in-coupling element and the out-coupling element are disposed on at least one of the front surface and the back surface;
wherein an in-coupling area is an area of the at least one of the front surface and the back surface on which the in-coupling element is disposed, and an out-coupling area is an area of the at least one of the front surface and the back surface on which the out-coupling element is disposed;
wherein at least one of the front surface and the back surface of the optical waveguide plate is a curved surface, and the curved surface is an aspheric surface;
wherein the in-coupling area has an in-coupling area standard point, and the out-coupling area has an out-coupling area standard point;
wherein an in-coupling area corresponding point is an intersection of the in-coupling area standard point from the at least one of the front surface and the back surface on which the in-coupling element is disposed extending towards the other one of the front surface and the back surface on which the in-coupling element is disposed along a normal line;
wherein an out-coupling area corresponding point is an intersection of the out-coupling area standard point from the at least one of the front surface and the back surface on which the out-coupling element is disposed extending towards the other one of the front surface and the back surface on which the out-coupling element is disposed along the normal line.

16. The optical waveguide plate of claim 15, wherein a curvature of the in-coupling area standard point is Cis, a curvature of the in-coupling area corresponding point is Cic, and the following condition is satisfied:
$$Cis \leq Cic .$$

17. The optical waveguide plate of claim 15, wherein a curvature of the in-coupling area standard point is Cis, a curvature of the out-coupling area standard point is Cos, and the following condition is satisfied:
$$Cis \leq Cos .$$

18. The optical waveguide plate of claim 15, wherein a curvature of the in-coupling area standard point is Cis, a curvature of the out-coupling area corresponding point is Coc, and the following condition is satisfied:
$$Cis \leq Coc .$$

19. The optical waveguide plate of claim 15, wherein a curvature of the in-coupling area standard point is Cis, a curvature of the in-coupling area corresponding point is Cic, and the following condition is satisfied:
$$Cic \leq Cis .$$

20. The optical waveguide plate of claim 15, wherein a curvature of the in-coupling area corresponding point is Cic, a curvature of the out-coupling area standard point is Cos, and the following condition is satisfied:
$$Cic \leq Cos .$$

21. The optical waveguide plate of claim 15, wherein a curvature of the in-coupling area corresponding point is Cic, a curvature of the out-coupling area corresponding point is Coc, and the following condition is satisfied:
$$Cic \leq Coc .$$

22. The optical waveguide plate of claim 15, wherein a curvature of the in-coupling area standard point is Cis, a curvature of the out-coupling area standard point is Cos, and the following condition is satisfied:
$$\vert Cos \vert \leq \vert Cis \vert .$$

23. The optical waveguide plate of claim 15, wherein a curvature of the in-coupling area corresponding point is Cic, a curvature of the out-coupling area corresponding point is Coc, and the following condition is satisfied:
$$\vert Coc \vert \leq \vert Cic \vert .$$

24. The optical waveguide plate of claim 15, wherein a curvature radius of the in-coupling area standard point is Ris, a curvature radius of the out-coupling area standard point is Ros, and the following condition is satisfied:
$$\vert Ris \vert \leq \vert Ros \vert .$$

25. The optical waveguide plate of claim 15, wherein a refractive index of the optical waveguide plate is N, and the following condition is satisfied:
$$1.8 \leq N .$$

26. The optical waveguide plate of claim 25, wherein a length of the out-coupling area is W, a thickness of the optical waveguide plate at the out-coupling area standard point is t, and the following condition is satisfied:
$$0.57 \leq W / 2 t \leq 1.00 \times 1 {0}^{18} .$$

27. An optical system, comprising:
the optical waveguide plate of claim 15; and
an image providing device disposed on a front side or a back side of the optical waveguide plate.

28. A near-eye display apparatus, comprising:
the optical system of claim 27; and
an outer cover carrier, wherein the optical system is disposed in the outer cover carrier.

29. The near-eye display apparatus of claim 28, wherein the near-eye display apparatus has at least one metasurface.

30. The near-eye display apparatus of claim 29, wherein the at least one metasurface is a composite achromatic metasurface.
